(19) United States
(12) Patent Application Publication
(10) Pub. No.: US 2007/0274872 A1
(43) Pub. Date: Nov. 29, 2007

(54) REACTANT DELIVERY SYSTEM AND REACTOR

(75) Inventors: KENGO MAKITA, Kanagawa (JP); TAKASHI TOMITA, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/754,777

(22) Filed: May 29, 2007

(30) Foreign Application Priority Data
May 29, 2006 (JP) 2006-147650

(51) Int. Cl. F01N 3/20; H01M 8/04

(52) U.S. Cl. 422/105; 429/34; 429/26; 422/198

(57) ABSTRACT

[Object] The present invention provides a reactant delivery system capable of delivering reaction gas with good control in both space and time despite its simple construction that it can be assembled in mobile equipment, and also a reactor provided with the reactant delivery system.

[Solving Means] The electrochemical energy generation system 50 has a fuel cell 10, a fuel delivery system 20, a measuring unit 30 for measuring an operation state of the fuel cell 10, and a control unit 40 for determining operation conditions on a basis of the results of the measurement. At an optimal rate determined by the control unit 40, the fuel is delivered in the form of gas from the fuel delivery system 20. The source fuel 21 such as methanol is introduced to between the backing portion 26 and the penetration and evaporation portion 27, the source fuel 21 evaporates into the fuel gas 13 from the surface of the penetration and evaporation portion 27.

### TECHNICAL FIELD

This invention relates to a reactant delivery system suited for use in a direct methanol fuel cell (DMFC) or the like, and also to a reactor having the reactant delivery system.

### BACKGROUND ART

As properties that indicate characteristics of a cell, there are energy density and power density. Energy density is the amount of energy stored per unit weight of the cell, and power density is a power output per unit weight of the cell. Lithium ion secondary cells are equipped two characteristics in combination, that is, relatively high energy density and very high power density, and are also much more accomplished. They have hence been adopted extensively as power supplies for mobile equipment. Keeping in step with the move toward mobile equipment of higher performance in recent years, their power consumption tends to increase. There is, accordingly, an outstanding demand for further improvements in the energy density and power density of lithium ion secondary cells.

Measures for meeting the above-mentioned demand include changing the electrode materials that make up cathodes and anodes, to improve the coating method of electrode materials, to improve the sealing method of electrode materials, and so on. Research is now under way for providing lithium ion secondary cells with improved energy density. There is, however, still too difficult to put them in practical use. No significant improvement can be expected in energy density insofar as the constituent materials currently employed in lithium ion secondary cells are changed.

Accordingly, the development of cells of still higher energy density as a replacement for lithium ion secondary cells is considered to be a matter of great urgency. Fuel cells are regarded as a promising candidate for such a replacement.

A fuel cell is constructed of an anode, a cathode, an electrolyte, and others. Fuel is delivered to the side of the anode, while air or oxygen is delivered to the side of the cathode. As a result, an oxidation-reduction reaction takes place on the anode and cathode so that the fuel is oxidized with oxygen. Therefore, a portion of the chemical energy which the fuel possesses is converted to electrical energy and is outputted.

A variety of fuel cells have been proposed and produced on trial basis to date, and some of them have already been put into practical use. Depending on the electrolytes employed, these fuel cells can be classified into alkaline electrolyte fuel cells (AFC), phosphoric acid fuel cells (PAFC), molten carbonate fuel cells (MCFC), solid oxide fuel cells (SOFC), polymer electrolyte fuel cells (PEFC), etc. Among these, polymer electrolyte fuel cells (PEFC) have an advantage that they can be operated at a temperature lower than the other fuel cells, for example, at a temperature of from 30° C. to 130° C. or so.

As fuel for fuel cells, various combustible materials such as hydrogen and methanol can be used. However, gaseous fuels such as hydrogen are not suited for a size reduction, because they need a storage cylinder or the like. Liquid fuels such as methanol, on the other hand, are equipped with an advantage that they can be readily stored. In particular, direct methanol fuel cells (DMFC) in which methanol is delivered directly to an anode for its reaction have an advantage that they do not need any reformer for the production of hydrogen from fuel, can be produced in a simpler construction, and can be readily reduced in size.

In DMFC, methanol as fuel is delivered generally as an aqueous solution of low concentration or high concentration or pure methanol is delivered in the form of gas, to the side of an anode, and in a catalyst layer on the anode side, is oxidized into carbon dioxide. The resulting protons migrate to a cathode through an electrolyte membrane that isolates the anode and cathode from each other, and on the cathode side, react with oxygen to form water. Reactions that take place at the anode and cathode and in the whole DMFC, respectively, are as shown by the following reaction formulas.
Anode: CH₃OH+H₂O→CO₂+6e⁻+6H⁺
Cathode: (3/2)O₂+6e⁻+6H⁺→3H₂O
Whole DMFC: CH₃OH+(3/2)O₂→CO₂+2H₂O

The energy density of methanol as fuel for DMFC is theoretically 4.8 kW/L, which is 10 times or more as much as the energy density of general lithium ion secondary cells. Fuel cells that use methanol as fuel, therefore, have significant possibility surpassing lithium ion secondary cells. For the foregoing reasons, DMFCs have the highest potential applicability as energy sources for mobile equipment, automotive vehicles and the like among various fuel cells.

DMFC is, however, accompanied by a problem that, although its theoretical voltage is 1.23 V, its output voltage is reduced to about 0.6 V or lower while it is actually generating power. This output voltage reduction is attributed to a voltage drop caused by internal resistances of DMFC. Inside DMFC, there are internal resistances such as a resistance produced as a result of the reactions occurred at the respective electrodes, a resistance produced as a result of movements of materials, a resistance produced upon migration of protons through an electrolyte membrane, and contact resistances. The energy that can be actually produced as electrical energy from the oxidation of methanol can be expressed by the product of an output voltage and the quantity of electricity flowing through a circuit, both during power generation. If the output voltage drops in the course of power generation, the energy that can be actually produced is reduced correspondingly. It is to be noted that the quantity of electricity, which can be outputted to the circuit by the oxidation of methanol, is proportional to the amount of methanol within DMFC provided that the methanol is oxidized in its entirety at the anode in accordance with the above-mentioned reaction formula.

DMFC also involves the problem of a methanol crossover. The term “methanol crossover” means a phenomenon that methanol is caused to permeate from the side of an anode to the side of a cathode through an electrolyte membrane in two mechanisms, one being the phenomenon that methanol diffusively moves owing to a difference in concentration between the anode side and the cathode side, and the other the electro-osmosis phenomenon that hydrated methanol is transported owing to a movement of water induced as a result of migration of protons.

When a methanol crossover occurs, permeated methanol is oxidized on a catalyst on the cathode side. A methanol oxidation reaction on the cathode side is the same as the above-mentioned oxidation reaction on the anode side, and causes a reduction in the output voltage of DMFC (see, for example, “Annotated Fuel Cell Systems” (in Japanese), page 66, Ohmsha, Ltd.). Further, methanol is not used for power generation on the anode side, but is wasted on the cathode side. The quantity of electricity that can be outputted to the circuit hence decreases correspondingly. The catalyst on the cathode side is not a Pt—Ru alloy catalyst but is a Pt catalyst, thereby developing such an inconvenience that CO is susceptible to adsorption on catalyst surfaces and catalyst poisoning occurs.

As described above, DMFC is accompanied by the two problems of a voltage drop caused by internal resistances and a methanol crossover and a fuel waste resulting from a methanol crossover. These problems are causes of a reduction in the power generation efficiency of DMFC. With a view to improving the power generation efficiency of DMFC, intensive research and development activities are now under way to provide DMFC-constituting materials with improved properties and also to optimize the operation conditions for DMFC.

As electrolyte membranes for DMFC, polyperfluoroalkylsulfonic acid resin membranes [for example, “NAFION” (registered trademark) membranes] are generally used these days. As anodic catalysts for DMFC, Pt—Ru catalysts are generally used these days. The research for providing DMFC-constituting materials with improved properties include research on and developments for membranes equipped with higher proton conductivity and methanol-permeation inhibiting ability than such polyperfluoroalkylsulfonic acid resin membranes, and also research on and developments for catalysts having higher activities than such Pt—Ru catalysts.

The research and developments for providing fuel-dell-constituting materials with improved properties as described above are suited as methods for providing fuel cells with improved power generation efficiency. For adequately controlling operation conditions, on the other hand, other research and developments are also important. For example, to make use of the high energy density which is a characteristic feature of fuel cells, it is essential to improve the power generation efficiency of each fuel cell by efficiently and stably delivering fuel to the anode of the fuel cell.

Fuel delivering methods for DMFC can be classified into two types, one being the liquid-delivery type that liquid methanol is delivered to an anode, and the other the gas-delivery type that gaseous methanol is delivered to an anode. Various methanol fuel delivery systems have been proposed to date, but those suited for small DMFC are limited.

As one suited for a size reduction, there is proposed, for example, in Patent Document 1 described later, a fuel cell that a fuel holding portion adjacent to an evaporation portion is constructed of a member capable of showing capillary effect, liquid fuel is delivered to the evaporation portion by allowing it to penetrate into the fuel holding portion, and the resulting gaseous fuel is delivered to the fuel cell. This fuel cell has an advantage that neither a pump nor a blower is necessary and its fuel delivery system can be simplified and reduced in size. It is also described that, as the gaseous fuel is delivered to an anode, the electrode reaction activity is high, a methanol crossover hardly takes place, and high performance can hence be obtained even under high load.

In Patent Document 2 described later, there is also proposed a fuel delivery system that liquid fuel is delivered to a reaction surface of an anode by capillary force through an effective porous structure. It is described that with this fuel delivery system, a drive unit such as a pump for the delivery of fuel can also be omitted to bring about an advantage that the fuel delivery system can be simplified and reduced in size.

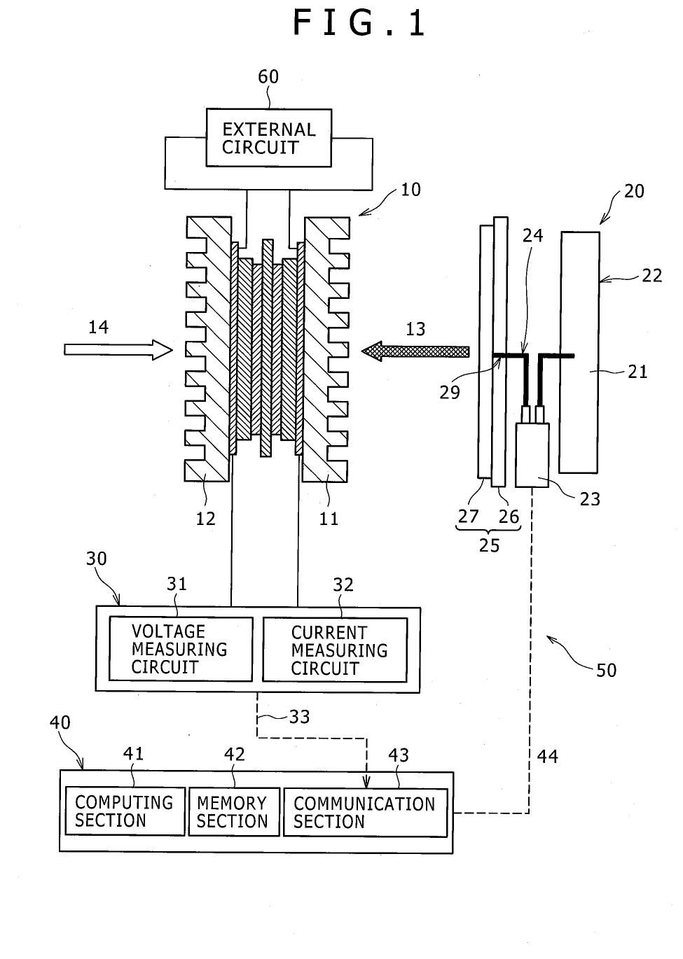

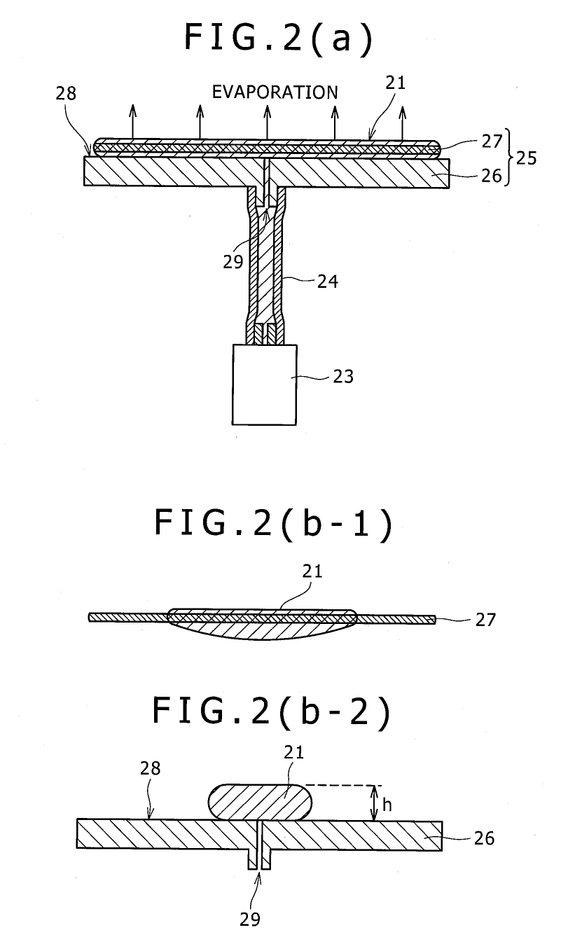

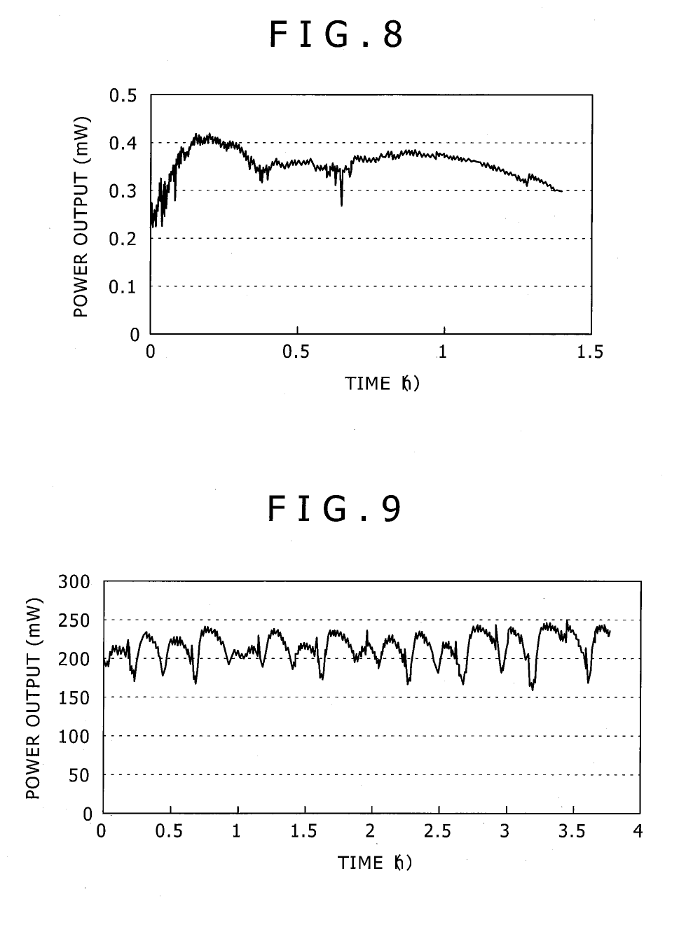

In Patent Document 3, there is also proposed a fuel cell that concentrated fuel of high fuel concentration is stored and recirculating fuel of low fuel concentration is delivered to the fuel cell. According to the proposed fuel cell, a fuel loss can be reduced, and concentrated fuel can be delivered with high accuracy even when the quantity of power generation varies.

[Patent Document 1] Japanese Patent Laid-open No. 2000-353533 (see pages 3-7, FIGS. 1 and 8) [Patent Document 2] JP-A-2005-524952 (see pages 4-6, FIGS. 2-4)

[Patent Document 3] Japanese Patent Laid-open No. 2005-93116 (see pages 5 and 6, FIG. 1)

The fuel delivery rate, however, cannot be finely controlled by any fuel delivery method making use of capillary effect, because the amount of fuel to be delivered by centrifugal force remains substantially constant. The fuel cell proposed in Patent Document 1 or the fuel delivery system disclosed in Patent Document 2 can generate the fuel cell only under substantially constant power-generation conditions set at the beginning, and falls in a surplus state of fuel delivery under low load conditions but in a shortage state of fuel delivery under high load conditions.

It is also known that in a direct methanol fuel cell (DMFC), the internal characteristics of the fuel cell vary moment after moment due to CO poisoning at its anodic catalyst, flooding at its cathode, deteriorations of its electrolyte membrane and the like, and the optimal fuel delivery rate hence varies moment after moment even when operated under constant conditions. When power generation is actually performed using DMFC, DMFC is expected to be used for from at least several months to one year or longer. During this period, the internal characteristics of the fuel cell unavoidably vary so that the operation conditions for maximizing the power generation efficiency of DMFC vary moment after moment. With a fuel delivery system which relies solely upon capillary force, it is impossible to deal with the internal characteristics of the fuel cell, the internal characteristics varying with time as mentioned above. No fine adjustments are, therefore, feasible with respect to the fuel delivery rate. As a consequence, a wasteful consumption of fuel takes place such as a crossover, leading to deteriorations in the fuel cell and also to a substantial reduction in the power generation efficiency of the fuel cell. It is, therefore, impossible to make good use of the inherent characteristic of the fuel cell that its energy density is high.

For permitting the stoppage of a fuel delivery in such a state that fuel still remains in a fuel tank, it is necessary to additionally arrange a fuel delivery control mechanism such as a shutter. As appreciated from the foregoing, even a fuel delivery method making use of capillary effect requires a certain fuel delivery control mechanism for the realization of practical functions. As a result, an increase in size is unavoidable. As recent advancements in technologies on micropumps and the like are remarkable, the fuel delivery methods making use of capillary effect cannot necessarily be considered to be superior in the reductions of size and power consumption to fuel delivery methods making use of a micropump or the like.

In the fuel cell proposed in Japanese Patent Laid-open No. 2005-93116, the system becomes large and complex because it stores both concentrated fuel and recirculating fuel. As the recirculating fuel is a mixture of concentrated fuel and water, it is impossible to make good use of the inherent characteristic of DMFC that its energy density is high.

As described above, there has not been realized yet any fuel delivery system which, while making good use of the high energy density as the characteristic of DMFC, can perform fine fuel delivery control and can deal with the internal characteristics of the fuel cell, the internal characteristics varying moment after moment.

With a view to resolving such problems as mentioned above, the present invention provides a reactant delivery system capable of delivering reaction gas with good control in both space and time despite its simple construction that it can be assembled in mobile equipment, and also a reactor provided with the reactant delivery system.

[Means for Solving the Problems]

In one embodiment of the present invention, there is thus provided a reactant delivery system for causing a liquid reactant to evaporate and delivering the reactant as a gaseous reactant into a reaction region, including: a first base member hardly wettable to the liquid reactant, a second base member formed of a material readily wettable to the gaseous reactant and capable of holding the liquid reactant and causing the liquid reactant to evaporate, the second base member being arranged in opposition to or in contact with the first base member, and a device for delivering the liquid reactant to between the first base member and the second base member.

In another embodiment of the present invention, there is also provided a reactor including the above-described reactant delivery system and a reaction region for allowing the reactant to react.

[Effects of the Invention]

The reactant delivery system according to an embodiment of the present invention includes the first base member hardly wettable to the liquid reactant and the second base member formed of the material readily wettable to the gaseous reactant and capable of holding the liquid reactant and causing the liquid reactant to evaporate. The second base member is arranged in opposition to or in contact with the first base member. The reactant delivery system according to an embodiment of the present invention further includes the device for delivering the liquid reactant to between the first base member and the second base member.

As the second base member is formed of the material readily wettable to the liquid reactant and has the property of holding the liquid reactant and causing it to evaporate, the liquid reactant delivered to between the first base member and the second base member can be held in the second base member and can evaporate from its surface. Because the first base member is formed of the material hardly wettable to the liquid reactant, the liquid reactant is repelled by the first base member at this time, and therefore, the liquid reactant is maintained in such a state that it is sealed on the side of the first base member. Compared with a case not provided with the first base member, there is a greater tendency that the liquid reactant is held in the second base member to evaporate from its surface. As a consequence, the reactant delivery system according to an embodiment of the present invention can spread the liquid reactant over a wide area while maintaining it in contact with the second base member, can cause it to efficiently evaporate from a wide surface, and hence, can deliver it as the gaseous reactant into the reaction region.

The reactor according to an embodiment of the present invention, on the other hand, has the reactant delivery system and the reaction region for allowing the reactant to react. By the reactant delivery system, the liquid reactant can be caused to efficiently evaporate and can then be delivered as the gaseous reactant into the reaction region. The reactor can, therefore, stably perform the reaction of the reactant.

### BEST MODE FOR CARRYING OUT THE INVENTION

In the reactant delivery system according to an embodiment of the present invention, it is preferred that:

the first base member is planar at a front surface thereof, and is provided with a through-hole extending from a side of a back surface of the first base member to the front surface,

the second base member is constructed in such a form as permitting holding of the liquid reactant therein, specifically in a reticulate or porous form,

the second base member is held in contact with the front surface of the first base member or with a slight clearance left relative to the front surface of the first base member, and

the liquid reactant delivered through the through-hole to between the second base member and the first base member evaporates from the front surface of the second base member subsequent to its penetration into the second base member.

When constructed as described above, the liquid reactant is guided to between the first base member and the second base member through the through-hole. As the first base member is formed of the material hardly wettable to the liquid reactant and its front surface is planar, the liquid reactant can spread on and along the front surface of the first base member, but on the side of the first base member, is in a completely-sealed state. On the side opposite to the gap, on the other hand, there is the second base member. This second base member is formed of the material readily wettable to the liquid reactant, is formed in the reticulate or porous form, can hold the liquid reactant, and can cause the liquid reactant to evaporate. Therefore, the liquid reactant sealed on the side of the first base member spreads widely on and along the planar front surface, promptly penetrates into the second base member, spreads in the form of a thin layer upwardly and in a planar direction while flowing through the second base member, and then efficiently evaporates from the widely-formed front surface into a vapor phase.

A distance between the first base member and the second member may preferably be not greater than a height of each droplet to be formed with the liquid reactant on the first base member. This is a necessary condition for the liquid reactant, which has been introduced onto the front surface of the first base member, to come into contact with the second base member.

An angle of contact between the first base member and the liquid reactant may preferably be at least 0 degree, and a surface tension of the first base member may preferably be smaller than that of the liquid reactant.

A surface tension of the second base member, on the other hand, may preferably be greater than that of the liquid reactant.

Further, a thickness of the second base member may preferably be not greater than 1 mm. As the thickness of the layer of the liquid reactant held in the second base member is determined by the thickness of the second base member, the thinner the layer of the second base member, the better for allowing the liquid reactant to spread as widely as possible.

It is preferred to allow the liquid reactant to evaporate naturally. This preferred embodiment can obviate heating means for evaporation, and therefore, is advantageous for reductions in the size and energy consumption of the reactant delivery system.

It is also preferred that the reactant supplying device according to an embodiment of the present invention has, as the reaction region, an electrochemical device unit including an anode, a cathode and an electrolyte arranged between the anode and the cathode and is constructed as an electrochemical device.

Preferably, the electrochemical device may be an electrochemical device capable of generating electrochemical energy, and may be constructed as an electrochemical energy generation system including:

a measuring unit for measuring an operation state of the electrochemical device unit,

a control unit for determining operation conditions for the electrochemical device unit on a basis of measurement results of the operation state, and a setting unit for setting the operation conditions for the electrochemical device on a basis of the determination.

Further, it is preferred that the electrochemical device unit is provided with a fuel delivery portion for delivering fuel to the anode and an oxygen-containing gas delivery portion for delivering oxygen-containing gas to the cathode and is constructed as a fuel cell. Preferably, the control unit may determine a fuel delivery rate as an operation condition for the fuel cell, and the setting unit may set the fuel delivery rate on a basis of the determination. More preferably, the control unit and setting unit may repeatedly perform the determination and setting such that a concentration of fuel at the anode can be optimized following variations in characteristics of the fuel cell.

As illustrative reactant delivery system and reactor according to embodiments of the present invention, a description will hereinafter be made with reference to the drawings about examples in which the reactant delivery system is constructed as a fuel delivery system for delivering gaseous fuel gas such as methanol, the electrochemical device unit is constructed as a fuel cell, such as a direct methanol fuel cell (DMFC), that the gaseous fuel gas is delivered as a reactant, and the reactor is an electrochemical energy generation system.

A description will firstly be made about a concept serving as a core of a fuel delivery system and fuel delivery structure required for operating DMFC with high power generation characteristics, because the internal characteristics of DMFC vary with time and an operation of DMFC with optimal power generation characteristics is hence very difficult without a fuel delivery system and fuel delivery means which permit fine adjustments.

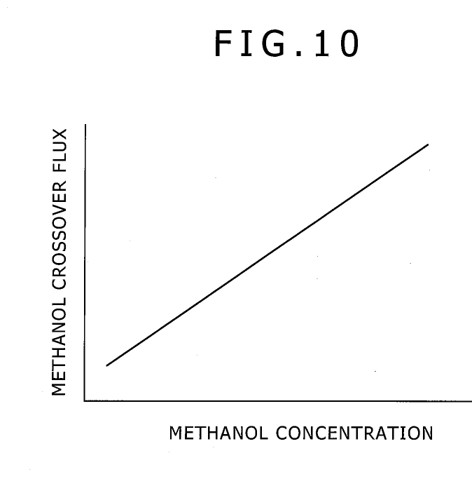

FIG. 10 is a graph showing effects of the concentration of methanol at an anode on the methanol crossover flux expressed in terms of equivalent current density. When the methanol concentration and the methanol delivery rate are in a proportional relationship, the graph of FIG. 10 can be considered to be a graph that shows effects of the methanol delivery rate at an anode on the methanol crossover flux. As shown in FIG. 10, the flux methanol crossover increases as the methanol concentration at the anode becomes higher (the delivery rate of methanol becomes greater). It has been confirmed that, unless the concentration of methanol at an anode is appropriate, fuel is wastefully consumed due to an increase in crossover and the power generation characteristics are substantially lowered due to a drop in output voltage (see, “Fuel Cells for Portable Equipment” (in Japanese), page 110, Technical Information Institute Co., Ltd.). Without such a fuel delivery system as always assuring the delivery of fuel at an adequate rate, the above-mentioned problems arise accordingly.

With a fuel delivery system which introduces liquid fuel into a DMFC cell by capillary force, the problems of methanol crossover cannot be resolved as mentioned above. If the internal characteristics of DMFC remained always constant, it would be possible to deal with the problems of methanol crossover by a fuel delivery system, which makes use of capillary force alone, provided that loads were constant. Actually, however, the internal characteristics vary moment after moment. The optimal fuel delivery rate, therefore, varies with the power generation time of DMFC. Accordingly, there is high possibility of the occurrence of methanol crossover due to an over-delivery, resulting in a reduction in power generation efficiency.

To operate DMFC with high power generation characteristics, a fuel delivery system, therefore, has to be such a system as capable of always maintaining an optimal fuel delivery rate in correspondence to the internal characteristics of DMFC, the internal characteristics varying moment after moment, to inhibit the occurrence of methanol crossover which would otherwise take place by over-deliveries.

FIG. 1 is a schematic block diagram illustrating the construction of an electrochemical energy generation system 50 according to an embodiment of the present invention. The electrochemical energy generation system 50 has a fuel cell 10 for converting a portion of chemical energy, which fuel has, to electrical energy, a fuel delivery system 20 for delivering fuel gas to the fuel cell 10, a measuring unit 30 for measuring an operation state of the fuel cell 10, and a control unit 40 for determining operation conditions on a basis of the results of the measurement. At an optimal rate determined by the control unit 40, the fuel is delivered in the form of gas from the fuel delivery system 20 to optimize the operation of the fuel cell 10.

More specifically, the operation voltage and operation current of the fuel cell 10 are measured during an operation of the fuel cell 10 to calculate the operation power output. Based on these measurement results, the fuel delivery rate is controlled as an operation condition for the fuel cell 10. By frequently repeating these measurements and the setting of the fuel delivery rate, the concentration of the fuel at an anode of the fuel cell 10 is optimized following variations in the characteristics of the fuel cell 10. It is to be noted that the fuel cell 10 corresponds to the above-described electrochemical device unit.

The fuel delivery system 20 is constructed such that source fuel 21 is stored in a fuel storage section 22 and the delivery rate of the fuel to be delivered to the fuel cell 10 is set by a fuel delivery section 23. No particular limitation is imposed on the fuel delivery section 23 insofar as it can be drive by a signal from the control unit 40. As an example, however, the fuel delivery section 23 may include a motor and a valve driven by a piezoelectric element, an electromagnetic pump, or the like.

The source fuel 21 is liquid fuel, for example, methanol, and before its delivery to the fuel cell 10, is stored in a tank or cartridge as the fuel storage section 22. The source fuel 21 is drawn from the fuel storage section 22 by the fuel delivery section 23 at a rate determined by the control unit 40, and is delivered to a fuel vaporization section 25 through a fuel delivery line 24. The source fuel 21 delivered to the fuel vaporization portion 25 is allowed to naturally evaporate into a gaseous form there. Resulting fuel gas 13 is delivered from the fuel vaporization section 25 to a fuel delivery portion 11 arranged on the side of the anode 6 in the fuel cell 10.

FIG. 2(a) is a schematic view showing the construction of the fuel evaporation section 25. The fuel evaporation section 25 is composed primarily of a backing portion 26 on a lower side and a penetration and evaporation portion 27 on an upper side. The backing portion 26 corresponds to the above-described first base member, while the penetration and evaporation portion 27 corresponds to the above-described second base member. A surface 28 of the backing portion 26 is planar, and a through-hole 29 is formed extending from the side of a back side to the surface 28. The through-hole 29 is in communication with the fuel delivery section 23 via the fuel delivery line 24, and its internal diameter may be from 100 μm to 2 mm or so, with a range of from 100 μm to 300 μm being more preferred. The penetration and evaporation portion 27 is constructed in such a form as permitting holding of the liquid fuel therein, specifically in a reticulate or porous form, and is held in contact with the surface 28 of the backing portion 26 or with a slight clearance left relative to the surface 28.

The source fuel 21 delivered from the fuel delivery section 23 passes through the fuel delivery line 24, and subsequently, is introduced to between the backing portion 26 and the penetration and evaporation portion 27 via the through-hole 29. As the backing portion 26 is formed of a material hardly wettable to the source fuel 21, the source fuel 21 introduced to between the backing portion 26 and the penetration and evaporation portion 27 is repelled by the backing portion 26 and is brought into a state sealed at a lower part thereof (in other words, supported from the lower part thereof). Above the gap, on the other hand, there is the penetration and evaporation portion 27 formed of a material wettable to the source fuel 21 and constructed in such a form as permitting holding of the liquid fuel therein, specifically in a reticulate or porous form. Accordingly, the source fuel 21 sealed at the lower part thereof promptly penetrates into the penetration and evaporation portion 27. After the source fuel 21 has spread upwardly and in a planar direction as a thin layer through the penetration and evaporation portion 27, the source fuel 21 evaporates into a vapor phase from the entire surface of the penetration and evaporation portion 27. At this time, the source fuel 21 may be considered to spread more easily in the planar direction because of an unbalance between a surface tension at a region of contact between the source fuel 21 and the backing portion 26 and a surface tension of the source fuel 21 at a region of contact between the source fuel 21 and the penetration and evaporation portion 27.

FIGS. 2(b-1) and 2(b-2) are schematic views of a comparative example included for the description of advantages of the above-described characteristic construction of the fuel evaporation section 25. When the fuel evaporation section 25 is not provided with the penetration and evaporation portion 27 as shown in FIG. 2(b-2), the source fuel 21 repelled by the backing portion 26 forms a tall droplet having a height h and does not spread widely over the backing portion 26. When the fuel evaporation section 25 is not provided with the backing portion 26 and the source fuel 21 is held in only the penetration and evaporation portion 27 as shown in FIG. 2(b-1), on the other hand, a space is provided to allow the source fuel 21 to hang down so that the source fuel 21 forms a thick layer. As a result, the tendency that the source fuel 21 spreads in a planar direction through the penetration and evaporation portion 27 is reduced by the surface tension of the source fuel 21.

Namely, the advantageous effects of the embodiment of the present invention can be exhibited by the holding of the penetration and evaporation portion 27 either in contact with the surface 28 of the backing portion 26 or with a slight clearance left relative to the surface 28. As understood from the above description, the smaller the thickness of a clearance between the penetration and evaporation portion 27 and the backing portion 26, the more desired. Even if the thickness of the clearance is large, it is necessary not greater than the height (i.e., h in FIG. 2(b-2)) of a droplet which the source fuel 21 forms on the surface 28 of the backing portion 26. To have the advantages of the fuel vaporization section 25 effectively exhibited, a thickness of 1 mm or smaller is preferred.

The thickness of the penetration and evaporation portion 27 may preferably be from 0.1 mm to 0.5 mm. The thickness of a layer of the source fuel 21 held in the penetration and evaporation portion 27 is significantly affected by the penetration and evaporation portion 27. To make the source fuel 21 spread as wide as possible, the thinner the thickness of the penetration and evaporation portion 27, the better.

The smaller the thickness of the backing portion 26, the better, because the dimension of the fuel cell in the direction of its thickness, including the fuel delivery system 20, can be substantially reduced. Further, the distance from the penetration and evaporation portion 27 to the anode 6 may preferably be 2 mm or less.

In the above-described embodiment, the source fuel 21 is delivered to between the backing portion 26 and the penetration and evaporation portion 27 from the back side of the backing portion 26 via the through-hole 29. As an alternative, the source fuel 21 can be delivered to between the backing portion 26 and the penetration and evaporation portion 27 from the side via a tube.

No particular limitation is imposed on the materials to be used in the fuel vaporization section 25. Based on the values of angles of contact, the surface tensions of materials and the surface tension of fuel, an optimal combination should preferably be chosen. A description will hereinafter be made about the selection of materials, which make up the backing portion 26 and the penetration and evaporation portion 27, and also about the details of the designing of fuel vaporization section 25.

The surface tensions of some commonly-known materials are shown in Table 1, and the surface tensions of some liquids are presented in Table 2. Further, the measurement values of contact angles between methanol and some materials are shown in Table 3. A material the surface tension of which is small has high symmetry and has no polarity, and therefore, is hardly wettable to water. The greater the surface tension, the more readily wettable to liquids and the more readily spreadable over a surface.

TABLE 1
Surface Tensions of Materials

| | Surface tension |
|---|---|
| Material | (dyne/cm) |
| Copper | 1100 |
| Iron | 2030 |
| Wood | 58-61 |
| TEFLON | 18 |
| Polyethylene | 31 |
| Polystyrene | 33 |
| Silicone resin | 20 |

TABLE 2
Surface Tensions of Liquids

| | Surface tension |
|---|---|
| Solvent | (dyne/cm) |
| Water | 72.7 |
| Ethylene glycol | 48.4 |
| Acetone | 24 |
| Methanol | 22.6 |
| Ethanol | 22.6 |

TABLE 3
Contact Angle to Methanol

| Material | Contact angle (degrees) |
|---|---|
| TEFLON-coated | 54 |
| stainless steel | |
| TEFLON | 43 |
| Silicone resin | 43 |

The construction of the fuel vaporization section 25 depends on the contact angles between the source fuel 21 and the materials of the fuel vaporization section 25, the surface tension of the source fuel 21, and the surface tensions of the materials of the fuel vaporization section 25.

The term “contact angle” means an angle θ produced by a liquid droplet placed on a solid surface and a surface area in contact with the liquid droplet. When θ is 0 degree, the liquid completely wets the solid surface in its entirety and spreads over the entire surface. When θ is greater than 0 degree but smaller than 90 degrees, the liquid spreads over a limited area and remains in the form of a droplet. When θ is greater than 90 degrees, the liquid does not spread at all over the solid surface and does not wet the surface. In a small amount, the liquid takes a form close to a sphere to minimize its area of contact.

The term “surface tension” indicates the surface free energy per unit area, and means a force produced when a liquid contracts to minimize its surface area.

The fuel vaporization section 25 can be composed of two or more layers, in which the lowermost layer is the backing layer 26 and the uppermost layer is the penetration and evaporation portion 27. A material to be used in the backing portion 26 should be chosen depending on the values of its contact angle and surface tension (surface energy) and the surface tension of fuel to be used. Materials to be used in the portions other than the backing portion 26 should be chosen depending on the values of their surface tensions (surface energies) and the surface tension of the source fuel 21. A material to be used in the penetration and evaporation portion 27 should be chosen depending on its contact angle and surface tension (surface energy) and the surface tension of the source fuel 21.

This embodiment will be described further by taking methanol as an example of the source fuel 21. It is, however, to be noted that no particular limitation is imposed on the fuel and alcohols other than methanol can also be used.

Liquid methanol (concentration: 99.9%) stored in the fuel storage section 22 is released onto the surface of the backing portion 26 from the fuel delivery section 23. The backing portion 26 needs to be constructed such that the source fuel 21 is prevented from spreading as much as possible. The backing portion 26 also needs to be formed with a non-penetrable material so that the backing portion 26 does not absorb the source fuel 21.

The material of the backing portion 26 is chosen depending on the value of the contact angle between the material and the source fuel 21. As mentioned above, no limitation is imposed on the value of the contact angle between the material of the backing portion 26 and the fuel, the greater the value, the better for preventing the source fuel 21 from spreading over the material surface. Described specifically, the material to be used in the backing portion 26 is characterized in that it has a property to repel the source fuel 21. It is preferred for the source fuel 21 to exist in a spherical form. By using the property that the fuel takes a spherical form, the fuel is caused to move in a vertical direction.

It is also necessary to take into consideration the surface energy of the material and the surface tension of the source fuel 21. This indication assumes the use of pure liquid methanol. As understood from the surface tensions of the liquids in Table 2, the surface tension of methanol is 22.6 dyne/cm. On a surface of a material having a surface tension higher than this value, methanol wets the surface of the material and spreads there. On a surface of a material having a surface tension lower than the above value, however, methanol does not spread.

On the material of the backing portion 26, it is preferred for the source fuel 21 to exist in a spherical form. It is, therefore, desired that the contact angle between the material and the source fuel 21 is 0 degree or greater and the surface tension of the material of the backing portion 26 is lower than the surface tension of a liquid to be used as the source fuel 21. When methanol is employed as fuel, the use of a TEFLON (registered trademark)-based or silicone-resin-based material is preferred.

When the diffusion layer is formed of two layers, it is composed of the backing portion 26 and the penetration and evaporation portion 27. Methanol naturally evaporates from the penetration and evaporation portion 27 as the uppermost layer, and is delivered to the anode. As mentioned above, the source fuel 21 is caused to move in the vertical direction by using the property of surface tension of the backing portion 26. The penetration and evaporation portion 27 as the uppermost layer in the fuel vaporization section 25, therefore, plays the role to cause the source fuel 21 to spread in a lateral direction.

The penetration and evaporation portion 27 needs to have such a construction that as properties of its material, pores exist innumerably to permit the penetration of fuel, because upon contact with methanol repelled from the surface of the backing portion 26, the penetration and evaporation portion 27 is required to cause the fuel to promptly spread in the lateral direction and to evaporate from its entire surface. Although limitation is imposed on the number of pores in the penetration and evaporation portion 27, the penetration and evaporation portion 27 can preferably be a porous structure. As the fuel spreads through and penetrates into the penetration and evaporation portion 27, no contact angle can be measured. This layer is, therefore, chosen based on the value of surface tension between the fuel and the material. Since the fuel is desired to spread over the entire surface of the layer, it is necessary to use, as the material of the penetration and evaporation portion 27, a material having a surface tension higher than that of methanol (22.6 dyne/cm) as the fuel.

This, however, does not mean that any material can be used as the penetration and evaporation portion 27 insofar as its surface tension is higher than 22.6 dyne/cm. When desired to provide the penetration and evaporation portion 27 with selectivity, it is necessary to choose a material having an adequate surface tension.

If it is desired to perform the delivery of fuel stably and efficiently, for example, the use of the fuel in the form of a mixture is not preferred because the concentration of the fuel unavoidably varies. Variations in the concentration of the fuel lead to variations in the evaporation rate or the like of the fuel so that the characteristics of the fuel cell become unstable.

As mentioned above, water necessarily takes a part in the reactions which occur at the anode and cathode, respectively, in DMFC. When pure methanol (99.9%) is used as fuel, a chemical reaction initiates on the anode side due to the water contained in the small amount, and 3 moles of water are formed on the cathode side per mole of methanol. The water occurred through such chemical reactions returns from the side of the cathode to the side of the anode by inverse diffusion caused by a concentration gradient, and is used again in the chemical reactions.

The amount of water which returns from the cathode side to the anode side by inverse diffusion is proportional to the value of a current at the time of power generation from the fuel cell. Especially in a high-current range, the amount of water to be returned by inversely diffusion becomes greater that of water to be used in the reactions so that water likely accumulates on the anode side.

As pure methanol is desired to evaporate naturally and stably, its mixing with a solvent such as water to be returned by inverse diffusion is not preferred. It is an essential condition to use such a material that repels water although it spreads and absorbs methanol. Accordingly, the selection of a natural vaporization layer having an adequate surface tension is an essential requirement. As the surface tension of water is 72.7 dyne/cm, the use of a material the surface tension of which falls within a range of from 72.7 to 22.6 dyne/cm makes it possible to avoid the mixing of methanol and water in the natural vaporization layer. Water which accumulates on the anode side does not cause any problem, because it is easy to incorporate a mechanism for the effective recovery or vaporization of water repelled in the natural vaporization layer.

When a mixture of water and methanol is used as fuel, it is only necessary to introduce into the natural vaporization layer a material the surface tension of which is 72.7 dyne/cm or higher.

As the value of the surface tension of fuel for the fuel cell differs from one fuel to another and the material to be used in the penetration and evaporation portion 27 has to be changed depending on the fuel, no particular limitation is imposed on the material to be used in the penetration and evaporation portion 27.

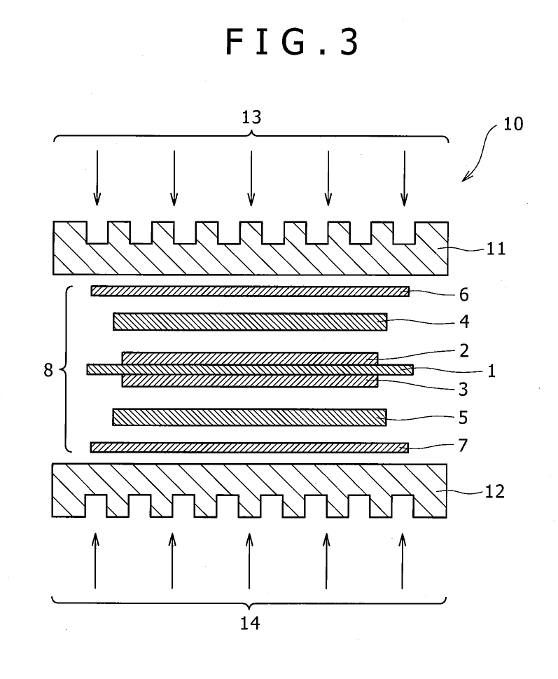

FIG. 3 is a cross-sectional view of the fuel cell 10 as the electrochemical device unit, which constitutes the electrochemical energy generation system according to this embodiment. Six fuel cells were connected in series to form a planar stack. It is, however, to be noted that in FIG. 3, the individual members of the fuel cell 10 are shown in an exploded state to facilitate their observation. The cross-sectional view of the assembled fuel cell 10 is shown in FIG. 1.

As depicted in FIG. 3, centering around a solid polymer electrolyte membrane 1 as the electrolyte, catalyst layers (anode catalyst layer 2 and cathode catalyst layer 3), diffusion layers (anode diffusion layer 4 and cathode diffusion layer 5), anode 6 and cathode 7 (anode current collector 6 and cathode current collector 7 are arranged on opposite sides of the electrolyte layer 1, respectively, in the fuel cell 10. They are integrated to form an MEA (membrane-electrode assembly) 8.

No particular limitation is imposed on the materials that make up the MEA 8. From known materials, suitable materials can be chosen as desired for use in the MEA 8. For example, as the solid polymer electrolyte member 1, a proton conducting membrane such as a perfluorosulfonic acid resin [e.g., “NAFION” (trademark), product of E.I. du Pont de Nemours and Company] or the like can be used. As catalyst forming the anode catalyst layer 2 and cathode catalyst layer 3, simple substances, such as palladium (Pd), platinum (Pt), iridium (Ir), rhodium (Rh) and ruthenium (Ru), or alloys of these metals can be selectively used. The anode diffusion layer 4 and cathode diffusion layer 5 can be formed of carbon cloths, carbon papers, carbon sheets or the like, and preferably, have been subjected to water repelling treatment with polytetrafluoroethylene (PTFE).

The characteristic features of the fuel cell 10 as the electrochemical device unit in the embodiment of the present invention reside in the arrangement of the fuel vaporization section 25 which can efficiently and stably deliver fuel. The fuel 13 is delivered in a vaporized form to the fuel delivery portion 11 via the fuel delivery system 20.

Upon power generation, the liquid fuel evaporates at the penetration and evaporation portion 27, and the fuel gas 13 such as methanol gas is delivered to the anode 6 and is oxidized into carbon dioxide at the anode catalyst layer 2. Protons produced at this time migrate to the side of the cathode through the solid polymer electrolyte membrane 1 which isolates the anode catalyst layer 2 and the cathode catalyst layer 3 from each other, and on the side of the cathode, react with oxygen to form water. The reactions which take place at the anode and cathode and in the whole DMFC are, for example, as expressed by the below-described reaction formulas, and a portion of the chemical energy of methanol or the like is converted to electrical energy and a current is outputted from the fuel cell 10.
Anode: CH₃OH+H₂O→CO₂+6e⁻+6H⁺
Cathode: (3/2)O₂+6e⁻+6H⁺→3H₂O
Whole DMFC: CH₃OH+(3/2)O₂→CO₂+2H₂O

This embodiment has been described taking methanol as an example of the source fuel 21. No particular limitation is, however, imposed on the fuel, and an alcohol other than methanol can be used as the fuel. As the form of the source fuel 21, liquid is preferred.

The measuring unit 30 is provided with a voltage measuring circuit 31 for measuring the voltage of the fuel cell 10 and a current measuring circuit 32 for measuring the current of the fuel cell 10. The measurement results obtained by these measuring means are transmitted to a communication section 43 in the control unit 40 via a communication line 33 during the operation.

As the control unit 40, a microcomputer or the like can be used, for example. The control unit 40 calculates power outputs from voltages and currents of the fuel cell 10 as sampled at constant intervals from the measurement results transmitted from the measuring unit 30, and based on the thus-calculated values, controls the fuel delivery system 20.

More specifically, the control unit 40 includes a computing section 41, a memory section 42, a communication section 43, etc. The communication section 43 is equipped with a function to receive data from the measuring unit 30 and to input them into the memory section 42 and also with a function to output signals, which set fuel delivery rates, to the fuel delivery section 23 via a communication line 44. The memory section 42 stores various measurement values from the measuring unit 30, the measurement values having been received by the communication section 43, and various average values calculated by the computing section 41. The computing section 41 averages anode potentials, cathode potentials, and output voltages and output currents of the fuel cell, which have been sampled at constant intervals from the various measurement results inputted to the memory section 42, to calculate an average anode potential, average cathode potential, average output voltage and average output current. Further, the comparison and computing section compares various average values stored in the memory section 42 with each other to determine whether or not the delivery rate of fuel is just enough.

More specifically, the control unit 40 includes a computing section 41, a memory section 42, a communication section 43, etc. The communication section 43 is equipped with a function to receive data from the measuring unit 30 and to input them into the memory section 42 and also with a function to output signals, which set fuel delivery rates, to the fuel delivery section 23 via a communication line 44. The memory section 42 stores various measurement values from the measuring unit 30, the measurement values having been received by the communication section 43, and various average values calculated by the computing section 41. The computing section 41 calculates the output of the fuel cell from voltage of the fuel cell and current of the fuel cell, which have been sampled at constant intervals from the various measurement results inputted to the memory section 42. Further, the computing section 41 compares various average values stored in the memory section 42 with each other to determine whether or not the delivery rate of fuel is just enough.

An external circuit 60 (load) represents mobile equipment [cellular phone, PDA (personal digital assistant: potable information equipment for personal use), or the like], and is driven by electrical energy generated at the fuel cell 10.

In the fuel delivery system 20 according to this embodiment, the backing portion 26 formed of the material hardly wettable to the source fuel 21 and the penetration and evaporation portion 27 formed of the material readily wettable to the source fuel 21 and constructed in such a form as permitting holding of the liquid reactant therein, specifically in a reticulate or porous form are arranged in opposition to or in contact with each other in the fuel vaporization section 25 as described above. The source fuel 21 introduced to between the backing portion 26 and the penetration and evaporation portion 27, therefore, promptly penetrates into the penetration and evaporation portion 27, spreads upwardly and in a planar direction as a thin layer through the penetration and evaporation portion 27, and then evaporates into a vapor phase from the entire surface of the penetration and evaporation portion 27. At the fuel vaporization section 25, it is therefore possible to cause the source fuel 21 to efficiently evaporate from the wide surface and to deliver the resulting fuel gas 13 into the reaction region.

The electrochemical energy generation system 50 according to this embodiment has the fuel delivery system 20 for delivering the fuel gas 13 into the fuel cell 10 as the reaction region. It is, therefore, possible to cause the liquid source fuel 21 to efficiently evaporate and to deliver it as the fuel gas 13 into the fuel cell 10. During the operation of the fuel cell 10, the measurement of operation conditions of the fuel cell 10 and the control of the fuel delivery rate based on the measurement results are frequently repeated to optimize the concentration of the fuel at the anode 6 of the fuel cell 10 in prompt response to variations in the characteristics of the fuel cell 10. As a result, the power generation efficiency can be improved. Especially when the fuel cell 10 is DMFC, methanol crossover can be suppressed to minimum so that a significant advantageous effect is available. Moreover, the fuel gas 13 is delivered to the anode 6 so that high electrode reaction activity is available and methanol crossover is hard to occur. High performance can, therefore, be obtained even under high loads.

### EXAMPLES

The present invention will hereinafter be described more specifically based on examples. It should, however, be borne in mind that the present invention shall not be limited to the following examples.

### Example 1

The fuel vaporization section 25 explained above in the description of the embodiment of the present invention (see FIG. 1 and FIG. 2) was fabricated, and the concentration of methanol gas naturally evaporated from the penetration and evaporation portion 27 in the fuel vaporization section 25 was measured in a real-time manner by a high-sensitivity room-temperature methanol sensor. With the sensor, methanol concentrations and their corresponding detected current values are in a proportional relation. Each methanol concentration was, therefore, shown by the current value of its corresponding detected current.

As the material for the backing portion 26 in the fuel vaporization section 25, a commercially-available PTFE (polytetrafluoroethylene) plate of 1.5 mm in thickness was employed. A small hole of 2 mm or so in diameter was formed through a central part of the PTFE plate, and was directly connected to a silicone tube as the fuel delivery line 24. As the penetration and evaporation portion 27 in the fuel vaporization section 25, a porous material of 0.2 mm in thickness (“SUN MAP”, trade name for porous film of ultra-high molecular weight polyethylene produced by Nitto Denko Corporation) was employed.

In this example, the PTFE plate was employed as the backing portion 26, and the silicone-based tube was used as the tube. However, the backing portion 26 and fuel delivery line 24 are not limited to them. Further, no limitations are imposed on the thickness of the PTFE plate and the diameter of the small hole. The thickness of the PTFE plate is, therefore, not limited to the above-specified value.

In the fuel storage section 22, on the other hand, pure methanol was charged. A suction opening of a pump as the fuel delivery section 23 was submerged in the pure methanol within the fuel storage section 22, and the silicone tube as the fuel delivery line 24 was connected to a discharge opening of the pump. The pump and the fuel vaporization section 25 were, therefore, connected together via the tube such that methanol was delivered to between the backing portion 26 and the penetration and evaporation portion 27 from the through-hole 28 of the backing portion 26.

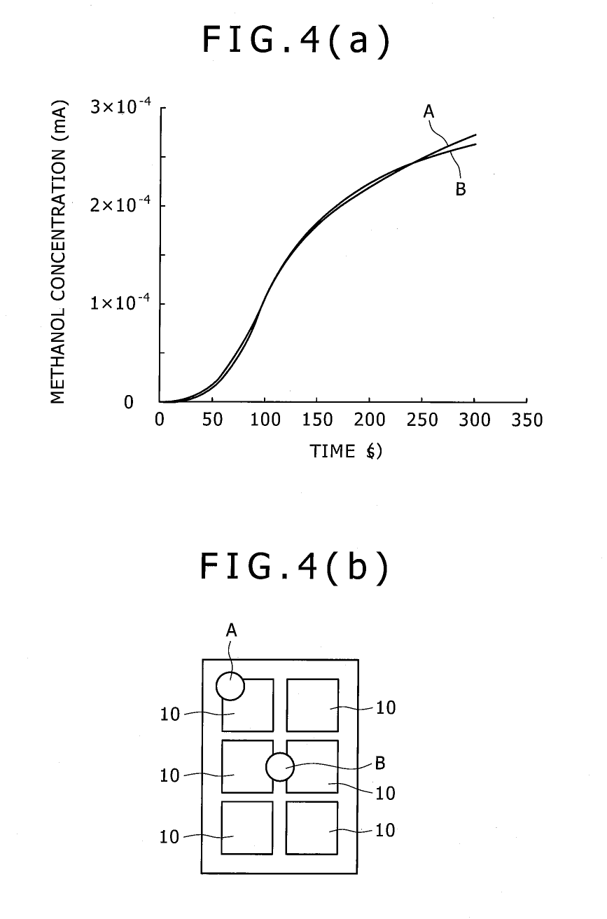

About the manner of spreading of the fuel in the planar direction through the fuel vaporization section 25, a test was firstly conducted by using two methanol sensors A,B (see FIG. 4). FIG. 4(a) is a graph illustrating time-dependent variations of the concentration of methanol gas produced by the fuel vaporization section 25, and FIG. 4(b) is a schematic view depicting the positions of the sensors. As depicted in FIG. 4(b), the two methanol sensors A, B were mounted at two locations on the fuel delivery portion 11 on the side of the anodes 6 in the fuel cells 10. The sensor B was mounted at the central part where a fuel spout opening (the through-hole 28) is located, while the sensor A was mounted in a corner.

As illustrated in FIG. 4(a), the time-dependent variations in the concentration of methanol as measured at the central part by the sensor B and the time-dependent variations in the concentration of methanol as measured in the corner by the sensor A substantially conform with each other. As a consequence, it has been proven that methanol delivered from the fuel spout opening (through-hole 28) at the central part instantly spreads in the planar direction through the fuel vaporization section 25 and methanol gas can hence be stably delivered at substantially the same concentration to all the electrodes in the six fuel cells 10.

The use of the fuel delivery system 20 according to the embodiment of the present invention, therefore, makes it possible to perform fine control of fuel delivery and also to achieve a stable and uniform delivery of fuel to the entire reaction region. As a consequence, it is possible to deal with variations in the internal characteristics of the fuel cell 10 and to always maintain maximum the power generation efficiency.

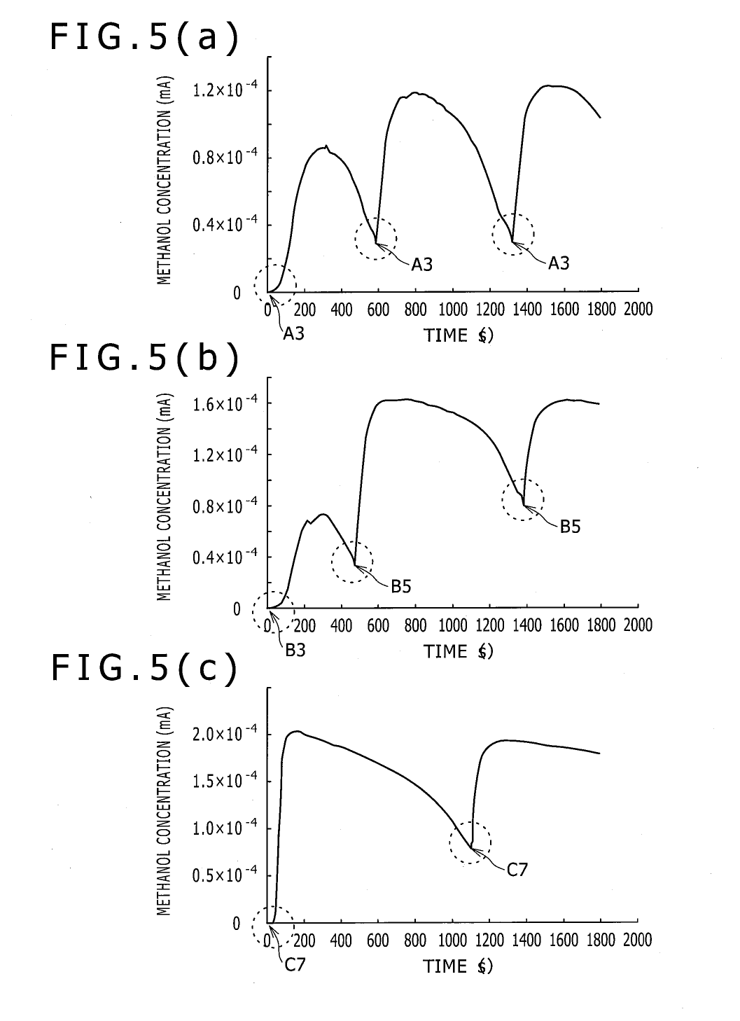

It will next be demonstrated that the fuel delivery rate can be controlled by combining the fuel vaporization section and the fuel delivery means together as in the embodiment of the present invention. FIGS. 5(a) to 5(c) are graphs illustrating time-dependent variations in the concentration of methanol gas produced by the fuel vaporization section 25.

FIG. 5(a) illustrates a case in which liquid methanol was delivered three times to the fuel vaporization section 25 by using three pumps at the same time. About 8 to 10 μL of the fuel was delivered each time from each pump (this will hereinafter apply equally). The time points indicated by sign A3 in FIG. 5(a) are the time points at which the fuel was delivered.

FIG. 5(b) shows a case in which liquid methanol was delivered three times to the fuel vaporization section 25 by using three or five pumps at the same time. The time point indicated by sign B3 in FIG. 5(b) is the time points at which the fuel was delivered by using the three pumps at the same time, while the time points indicated by sign B5 in FIG. 5(b) are the time points at which the fuel was delivered by using the five pumps at the same time.

FIG. 5(c) depicts a case in which liquid methanol was delivered twice to the fuel vaporization section 25 by using seven pumps at the same time. The time point indicated by sign C7 in FIG. 5(c) is the time point at which the fuel was delivered by using the seven pumps at the same time.

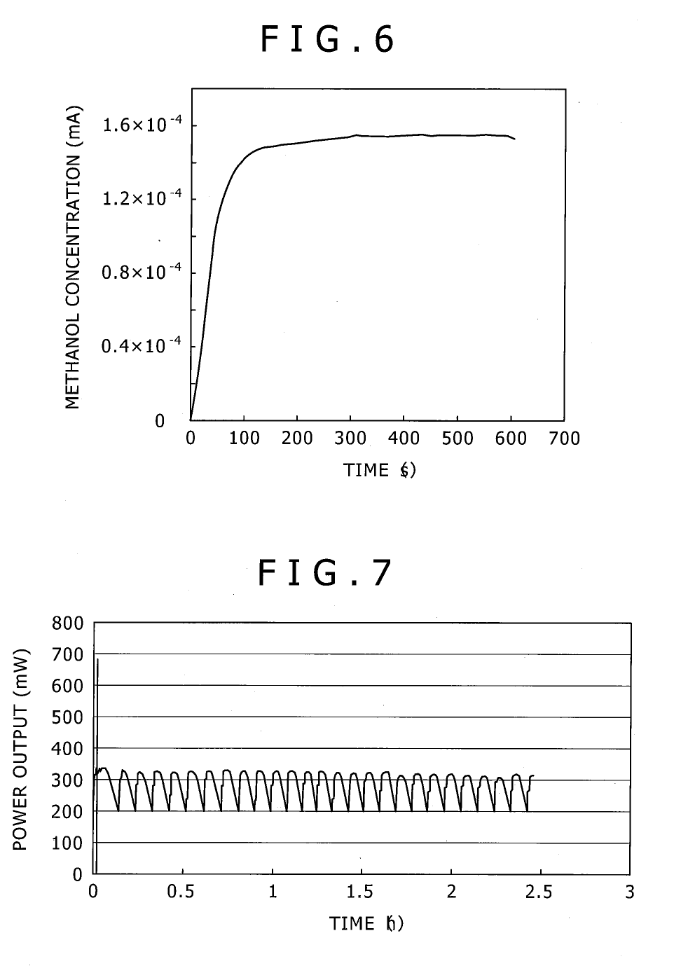

FIG. 6 is a graph illustrating time-dependent variations in the concentration of methanol gas produced by the fuel vaporization section of the comparative example in which the fuel was delivered by capillary effect.

As understood from a comparison between FIGS. 5(a) to 5(c) and FIG. 6, the combination of the fuel vaporization section 25 and the fuel delivery section 23 as in the embodiment of the present invention makes it possible to finely control the delivery rate of fuel. According to the fuel delivery making use of capillary effect in the comparative example, on other hand, the delivery rate of fuel cannot be controlled although the delivery of fuel can be performed stably. It is, therefore, impossible to deal with variations in the internal characteristics of the fuel cell. In addition, no change-over can be performed, for example, between high-voltage power generation and low-voltage power generation. As a consequence, the power generation efficiency cannot be maximized by the fuel delivery method that makes use of capillary effect.

### Example 2

The fuel vaporization section 25 fabricated in Example 1 was incorporated to fabricate the electrochemical energy generation system of FIG. 1, and its performance was evaluated.

<Fabrication of Fuel Cells>

As the electrochemical device unit, the fuel cell 10 shown in FIG. 3 were fabricated.

The anode catalyst layer 2 was prepared by mixing carbon, on which an alloy catalyst formed of Pt and Ru at a predetermined ratio was carried, and a “NAFION” dispersion at a predetermined ratio. The cathode catalyst layer 3 was prepared by mixing carbon, on which Pt was carried as a catalyst, and a “NAFION” dispersion at a predetermined ratio.

The electrolyte membrane 1 (“NAFION NRE211”, trade mark; product of E.I. du Pont de Nemours and Company) was placed between the anode catalyst layer 2 and cathode catalyst layer 3 prepared as described above, followed by thermocompression bonding for 10 minutes at 150° C. and 249 kPa.

The electrolyte membrane 1 with the anode catalyst layer 2 and cathode catalyst layer 3 thermocompression-bonded thereon was placed between carbon papers (“HGP-H-090”, trade name; products of Toray Industries, Inc.) corresponding to the anode diffusion layer 4 and cathode diffusion layer 5, and further between titanium meshes corresponding to the anode (anode current collector) 6 and cathode (cathode current collector) 7. The resulting stacked structure was integrated to prepare the MEA 8. Such MEAs were prepared as many as six. They were connected in series to fabricate an electrochemical device unit formed of a planar stack of 6 DMFCs connected in series.

<Fabrication of Electrochemical Energy Generation System>

The fuel cell was assembled in the electrochemical energy generation system 50 shown in FIG. 1. The electrochemical energy generation system 50 was connected to an electrochemical measuring instrument (“MULTISTAT 1480”, trade name; manufactured by Solartron Metrology Ltd.) and was then caused to operate in a constant-voltage output (0.3 V) mode and in a constant-current output (100 mA) mode. During the operation, detection of fuel shortage, detection of fuel shortage, detection of air shortage and detection of fuel crossover were performed.

On the other hand, 100% methanol was filled in a liquid fuel storage container. The liquid fuel storage container was connected to a suction opening of a pump as the fuel delivery section 23 via a silicone tube as the fuel delivery line 24, and a spout opening of the pump was connected to the fuel vaporization section 25 via a silicone tube.

<Characteristics of the Electrochemical Energy Generation System>

In this example, major causes for reductions in the power generation characteristics of a fuel cell were specified. By certain model experiments, relations between these causes and the potentials at the anode and cathode relative to reference electrodes and the output voltage and output current of the fuel cell were revealed. By the use of reference electrodes, it was then possible to establish a method for performing appropriate control even under different operation conditions. Using the fuel vaporization section 25 of the above-described construction, power generation was performed at room temperature.

FIG. 7 is a graph showing time-dependent variations in the potentials at the anode and cathode relative to those at the reference electrodes 9 and also in the output voltage of the fuel cell 10 in an initial stage of a measurement of the electrochemical energy generation system of this example.

The fuel cell 10 was operated while controlling the voltage. Specifically, the fuel cell 10 was operated within a voltage range of from 1.5 V to 1.7 V (low voltages). Whenever the output of the fuel cell dropped below 200 mW, the fuel was delivered at an optimal rate by the pump. The results are shown in FIG. 3. Those data were obtained when power generation was performed for 2 hours and a half. Whenever the output of the fuel cell dropped below 200 mW, the optimal amount of the fuel was delivered and the output increased. As the output was stable, the fuel cell 10 was confirmed to be a small fuel having high reliability.

FIG. 8 illustrates the characteristics of the fuel cell 10 when the fuel cell 10 was caused to generate power by delivering fuel under capillary effect as a comparative example. To maintain the fuel delivery rate constant, the fuel cell 10 has to be operated under substantially constant conditions. When fuel was delivered by using capillary effect, the fuel delivery rate cannot be controlled finely. Depending on the operation state of the fuel cell, the fuel cell 10 hence falls in a fuel shortage state or a fuel surplus state. To prevent the fuel cell 10 from falling in such a state, the fuel cell 10 was, therefore, caused to operate in such a voltage range (around 1.5 V) that the fuel cell 10 was able to stably generate power. As understood from the characteristics of FIG. 4, it is envisaged that despite the availability of an output of 350 W on average, the fuel cell 10 was unable to flexibly deal with internal variations caused by the power generation and the characteristics were not stable. It was also understood that as a result, the power generation efficiency was as low as 446 mW (446 mW/mL) per mL of the fuel.

FIG. 9 illustrates that the fuel cell of the example operated at 2.0 V and higher as a result of its control to operate at high voltages. It has, therefore, been proven that the introduction of the fuel vaporization section and fuel delivery means makes it possible to operate the fuel cell in various modes. In FIG. 7, the fuel cell was caused to operate at low voltages. In FIG. 9, on the other hand, the fuel cell was operated at high voltages and the power generation efficiency was substantially improved. It has been found that the use of the fuel delivery means and fuel vaporization section makes it possible to perform a fuel delivery in correspondence to the characteristics of the fuel cell. It was understood that as a result, the power generation efficiency was higher than that of the fuel cell relying solely upon capillary effect and was 790 mW per mL of the fuel (790 mW/mL).

As has been described above, the fuel delivery system 20 of this example makes it possible to spread liquid fuel over a wide area, to stably vaporize and deliver the fuel, and hence to maximize the power generation efficiency. The use of the fuel delivery system 20 of this example can always deliver fuel stably and efficiently without being affected by variations in the internal characteristics of the fuel cell. It is, hence, possible to make good use of the high energy density which the fuel cell has.

The present invention has been described above on the basis of its embodiment and examples. The above-described embodiment and examples can, however, be modified in various ways on the basis of the technical concept of the present invention.

For example, the shape, material and the like of the electrochemical device can be selectively changed as needed in the electrochemical energy generation system according to the present invention. Further, no particular limitations are imposed on the arrangement positions of the control unit, measuring unit, adjusting unit, electrochemical device unit, etc. in the system according to the present invention.

### BRIEF DESCRIPTION OF THE DRAWINGS

[FIG. 1] FIG. 1 is a schematic block diagram illustrating the construction of an electrochemical energy generation system according to an embodiment of the present invention.

[FIG. 2] FIG. 2(a) is a schematic view illustrating the construction of a fuel vaporization section in the electrochemical energy generation system and its effects, and FIGS. 2(b-1) and 2(b-2) are schematic views illustrating problems of a comparative example.

[FIG. 3] FIG. 3 is a cross-sectional view showing the construction of a fuel cell as an electrochemical device unit in the electrochemical energy generation system.

[FIG. 4] FIG. 4(a) is a graph showing time-dependent variations in the concentration of methanol gas produced by a fuel vaporization section in Invention Example 1, and FIG. 4(b) is a schematic view illustrating the positions of sensors.

[FIG. 5] FIGS. 5(a) to 5(c) are graphs depicting time-dependent variations in the concentration of methanol gas produced by the fuel evaporation section.

[FIG. 6] FIG. 6 is a graph illustrating time-dependent variations in the concentration of methanol gas produced by a fuel vaporization section in a comparative example.

[FIG. 7] FIG. 7 is a graph showing time-dependent variations in the power generation output of a fuel cell in Invention Example 2 (when operated in a low voltage mode).

[FIG. 8] FIG. 8 is a graph depicting time-dependent variations in the power generation output of a fuel cell of a comparative example.

[FIG. 9] FIG. 9 is a graph illustrating time-dependent variations in the power generation output of the fuel cell in Invention Example 2 (when operated in a high voltage mode).

[FIG. 10] FIG. 10 is a graph showing an effect of the concentration of methanol at an anode on the methanol crossover flux.

### DESCRIPTION OF REFERENCE SYMBOLS

1: electrolyte membrane, 2: anode catalyst layer, 3: anode catalyst layer, 4: anode diffusion layer, 5: anode diffusion layer, 6: anode (anode current collector), 7: cathode (cathode current collector), 8: MEA, 10; fuel cell, 11: fuel delivery portion, 12: air (oxygen) delivery portion, 13: fuel gas, 14: air (oxygen), 20: fuel delivery system, 21: source fuel, 22: fuel storage means, 23: fuel delivery means, 24: fuel delivery line, 25: fuel vaporization section, 26: backing portion, 27: penetration and evaporation portion, 28: surface, 29: through-hole, 30: measuring unit, 31: voltage measuring circuit, 32: current measuring circuit, 33: communication line, 40: control unit, 41: computing section, 42: memory section, 43: communication section, 44: communication line, 50: electrochemical energy generation system, 60: external circuit

1-13. (canceled)

14. A reactant delivery system for causing a liquid reactant to evaporate and delivering said reactant as a gaseous reactant into a reaction region, comprising:
a first base member hardly wettable to said liquid reactant,
a second base member formed of a material readily wettable to said gaseous reactant and capable of holding said liquid reactant and causing said liquid reactant to evaporate, said second base member being arranged in opposition to or in contact with said first base member, and
a device for delivering said liquid reactant to between said first base member and said second base member.

15. The reactant delivery system according to claim 1, wherein:
said first base member is planar at a front surface thereof, and is provided with a through-hole extending from a side of a back surface of said first base member to said front surface,
said second base member is constructed in such a form as permitting holding of said liquid reactant therein, specifically in a reticulate or porous form,
said second base member is held in contact with said front surface of said first base member or with a slight clearance left relative to said front surface of said first base member, and
said liquid reactant delivered through said through-hole to between said second base member and said first base member evaporates from said front surface of said second base member subsequent to its penetration into said second base member.

16. The reactant delivery system according to claim 1, wherein a distance between said first base member and said second member is not greater than a height of each droplet to be formed with said liquid reactant on said first base member.

17. The reactant delivery system according to claim 1, wherein an angle of contact between said first base member and said liquid reactant is at least 0 degree, and a surface tension of said first base member is smaller than that of a fuel.

18. The reactant delivery system according to claim 1, wherein a surface tension of said second base member is greater than that of said liquid reactant.

19. The reactant delivery system according to claim 1, wherein a thickness of said second base member is not greater than 1 mm.

20. The reactant delivery system according to claim 1, wherein said liquid reactant naturally evaporates.

21. A reactor comprising:
a reactant delivery system according to claim 1, and a reaction region for allowing said reactant to react.

22. The reactor according to claim 8, wherein said reactor has, as said reaction region, an electrochemical device unit comprising an anode, a cathode and an electrolyte arranged between said anode and said cathode, and said reactor is constructed as an electrochemical device.

23. The reactor according to claim 9, wherein said electrochemical device is an electrochemical device capable of generating electrochemical energy, and is constructed as an electrochemical energy generation system comprising:
a measuring unit for measuring an operation state of said electrochemical device unit;
a control unit for determining operation conditions for said electrochemical device unit on a basis of measurement results of said operation state; and
a setting unit for setting said operation conditions for said electrochemical device on a basis of said determination.

24. The electrochemical energy generation system according to claim 9, wherein said electrochemical device unit provides fuel to said anode and oxygen-containing gas to said cathode, and is constructed as a fuel cell.

25. The electrochemical energy generation system according to claim 11, wherein a fuel delivery rate is set as an operation condition for said fuel cell.

26. The electrochemical energy generation system according to claim 12, wherein said control unit and setting unit repeatedly perform said and setting such that a concentration of fuel at said anode can be optimized following variations in characteristics of said fuel cell.
